(19) United States
(12) Patent Application Publication
(10) Pub. No.: US 2006/0136381 A1
(43) Pub. Date: Jun. 22, 2006

(54) Method and system for a text based search of a self-contained document

(76) Inventors: Howard Justin Glaser, San Jose, CA (US); Michael Peter Etgen, Cary, NC (US)

Correspondence Address: SAWYER LAW GROUP LLP, P.O. Box 51418, Palo Alto, CA, 94303, US

(21) Appl. No.: 11/016,030

(22) Filed: Dec. 17, 2004

(51) Int. Cl. G06F 17/30

(52) U.S. Cl. 707/3

(57) ABSTRACT

A method for a text based search is disclosed. The method comprises providing search results which include at least one indexed self contained document. The method also includes obtaining a search term from a previous URL of the at least one self contained document by a broker, the broker including the unique identifier (UID) of the at least one self contained document. Additionally, the method includes mapping the UID to an actual URL of the at least one included self contained document by the broker. Finally, the method comprises linking to the at least one self contained document, by the broker. A system and method in accordance with the present invention includes a web based (non visual) mediator/broker which has logic to acquire information necessary to pass requests to another web resource via parameters passed in the URL and/or by retrieving the previous URL and examining its content. In the current implementation, the broker is used in conjunction with a search engine containing a fully text indexed document which represents an entire Information Center. The document is indexed with a URL that includes a unique identifier (UID) as a parameter. This URL points to the broker and the UID is mapped to a specific Information Center.

### FIELD OF THE INVENTION

The present invention relates generally to text based searches and more particularly to providing text based searches for a self-contained document.

### BACKGROUND OF THE INVENTION

The primary mechanism used to locate documents on a web site is text based search. Typically the documents returned in the search application contain links to static documents or a landing page. There are a number of instances where a mediating process is needed to connect disparate web resources and functions to seamlessly maintain the user's context when performing a task. For example, there are on-line libraries which are built as self-contained document repositories. It is advantageous for users to be able to search multiple libraries from a single point in a large web site and find relevant information in any of these libraries. Unfortunately, many of these libraries have their own search engines, unique document retrieval mechanisms, and closed internal structures. As such, they are not easily federated into a single search.

A large organization may have a number of these libraries published on their web site. Devising a single search application that both searches the content of these separate libraries and is able to retrieve the pages where hits are detected is problematic. While it is possible to extract the text content from these libraries and index them in one search engine, it may not be possible to navigate and retrieve specific information via a static HTML link to the library. While the search engine can find a text match, it cannot localize the hit to a single page and make that page retrievable as a link when the library is a closed single access point entity.

Accordingly, what is needed is a system and method for allowing search engines to easily access information in self-contained documents. The system and method should be easily implemented utilizing existing search tools, should be cost-effective and adaptable to existing computing systems. The present invention addresses such a need.

### SUMMARY OF THE INVENTION

A method for a text based search is disclosed. The method comprises providing search results which include at least one indexed self contained document. The method also includes obtaining a search term from a previous URL of the at least one self contained document by a broker, the broker including the unique identifier (UID) of the at least one self contained document. Additionally, the method includes mapping the UID to an actual URL of the at least one included self contained document by the broker. Finally, the method comprises linking to the at least one self contained document, by the broker.

A system and method in accordance with the present invention includes a web based (non visual) mediator/broker which has logic to acquire information necessary to pass requests to another web resource via parameters passed in the URL and/or by retrieving the previous URL and examining its content. In the current implementation, the broker is used in conjunction with a search engine containing a fully text indexed document which represents an entire Information Center. The document is indexed with a URL that includes a unique identifier (UID) as a parameter. This URL points to the broker and the UID is mapped to a specific Information Center.

### BRIEF DESCRIPTION OF THE DRAWINGS

FIG. 1 illustrates a web service client environment in accordance with the present invention.

FIG. 2 illustrates the operation of the content packager.

FIG. 3 illustrates the work flow describing roles and responsibilities of the administrator and the broker.

FIG. 4 is a diagram which illustrates the search for a self contained document in accordance with the present invention.

FIG. 5 is a block diagram which illustrates the broker's capability.

FIG. 6 is a first embodiment of a flow diagram which illustrates an example of how a system and method in accordance with the present invention operates in the case of calling an indexed Information Center from search engine's results page and passing the request to a broker.

FIG. 7 is a flow diagram of a second embodiment which illustrates an example of how a system and method in accordance with the present invention operates in the case of calling an indexed Information Center from search engine's results page and passing the request to a broker.

### DETAILED DESCRIPTION

The present invention relates generally to text based searches and more particularly to providing text based searches for a self-contained document. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention allows search engines to search self contained/closed document repositories more effectively as well as offering a general solution to integrate search link results with any resource that is programmatically addressable as a web source. Further, a method and system in accordance with the present invention serves as an intelligent broker which can be programmed with logic to conditionally provide different links or parameter inputs based on information passed to the broker and/or information the broker can acquire from the calling party and its environment.

In a preferred embodiment, a broker is utilized in the form of a JSP or an ASP that can programmatically invoke an API of another self contained document. The broker maps incoming requests to a web resource via conditionally invoking preprogrammed mappings. To describe the features of the present invention in more detail, refer now to the following description in conjunction with the accompanying figures.

Environment

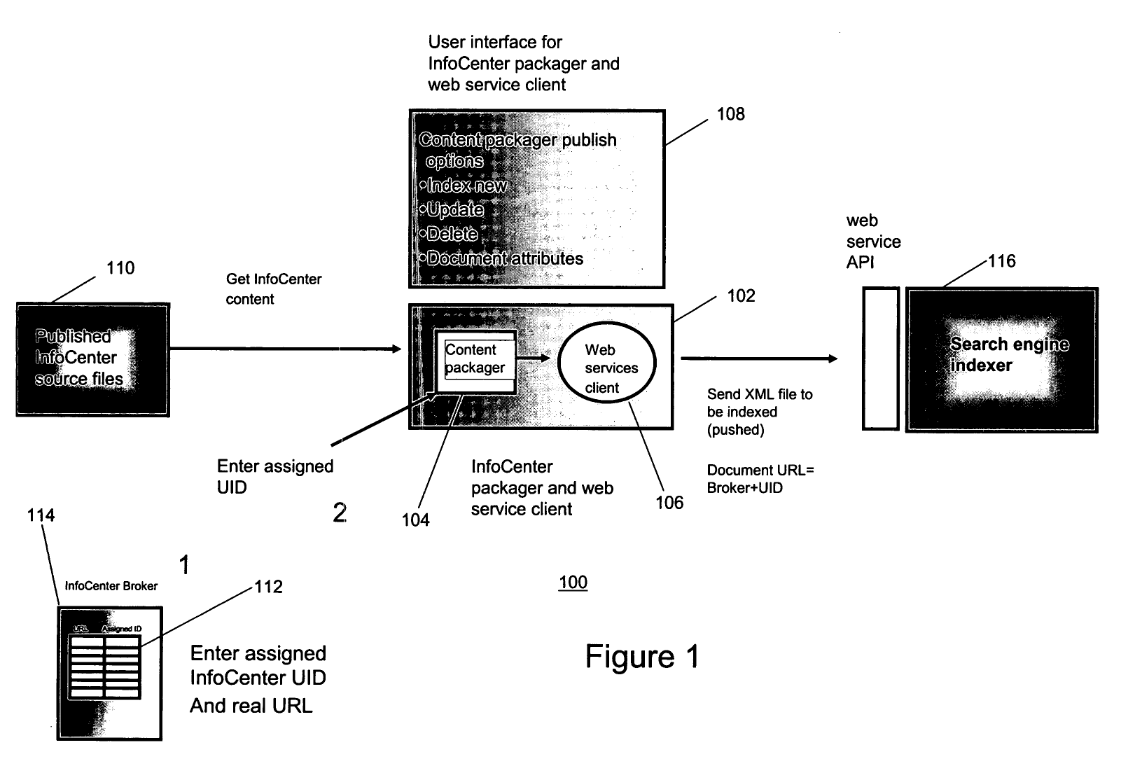

FIG. 1 illustrates a web service client environment 100 in accordance with the present invention. The environment 100 includes an Information Center package and web service client 102. The package/client includes a content package 104 and a web services client 106. A user interface 108 allows for a plurality of content package operations, for example, indexing new Information Centers, updating the Information Center, deleting information and providing attributes on the object. The user interface 108 provides a mechanism to import published Information Center source files 110. An administrator enters an assigned unique identifier (UID) 112 discussed in detail hereinafter to both the content package 104 and the broker 114. The administrator enters a published URL location of the Information Center 110 in the broker 114. The content package 104 and web service client 106 sends the file to be indexed (or pushed) to a search engine indexer 116. The search engine indexer 116 can be utilized in conjunction with a search engine which utilizes push technology. This type of search engine allows documents to push into its indexing system. A search engine which could be utilized in such a system is a Fast Search and Transfer (FAST) search engine.

Indexing the Self Contained Information

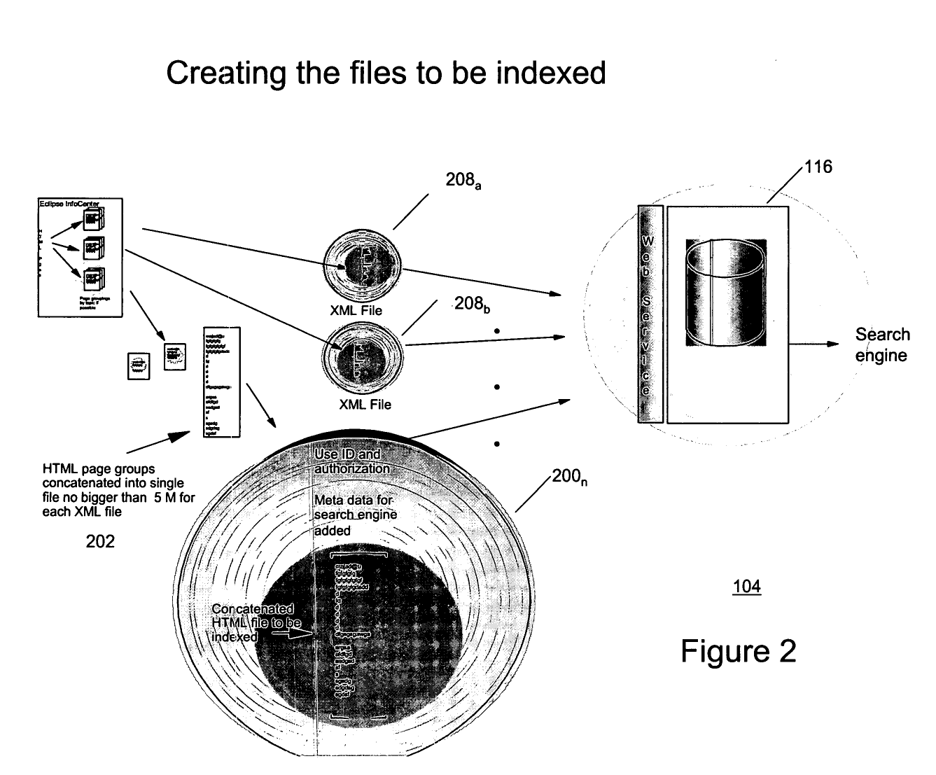

FIG. 2 illustrates the operation of the content packager 104. The content packager 104 takes pages from the document and sequentially appends them to each other 202. It takes the appended pages and submits them to an indexer as a single file. In one embodiment the entire document would be appended together as a plurality of sequential HTML pages. These HTML pages are provided as an XML file 208a-208n to the indexer.

Although an entire document file can be placed on a single XML file, some indexers may require smaller files. Accordingly, it may be desirable to break them into smaller sizes for use by the indexer. The process to index the self-contained information requires an administrator and a self contained information/Information Center owner. To describe this function refer now to the following description in conjunction with the accompanying figures.

The Administrator

The role of the administrator is to provide Information Center owners with the tools and a process to index the Information Center. Specifically the administrator is responsible for:

1. Ensuring that each Information Center has a unique identifier.

2. Configuring the broker to redirect link requests to the owner's published Information Center URL.

3. Providing the Information Center owner (or their representatives) with access/authorization to the indexing tool.

4. Enforcing any policies on when indexing can occur and any file size limitations.

The administrator can be a person, an automated process or any other mechanism to perform these tasks. In a preferred embodiment, an individual performs the tasks.

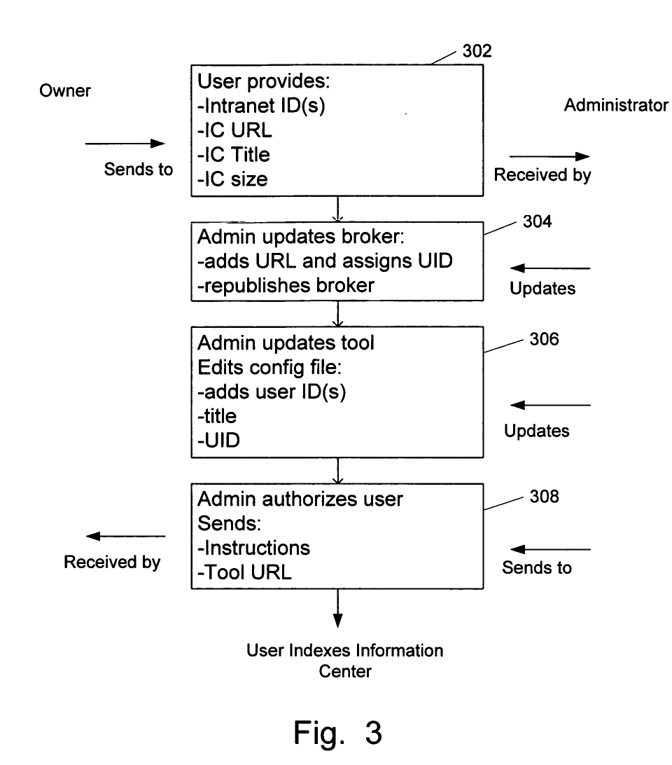

FIG. 3 illustrates the work flow describing roles and responsibilities of the administrator and the broker. As can be seen, the owner provides the administrator with intranet IDs for those who will be using the service, the full title of the Information Center, its location, and its size, via step 302. The administrator updates the broker and the tool via steps 304 and 306 with the information sent by the user and authorizes the user to logon and index their Information Center, via step 308.

Updating the Broker

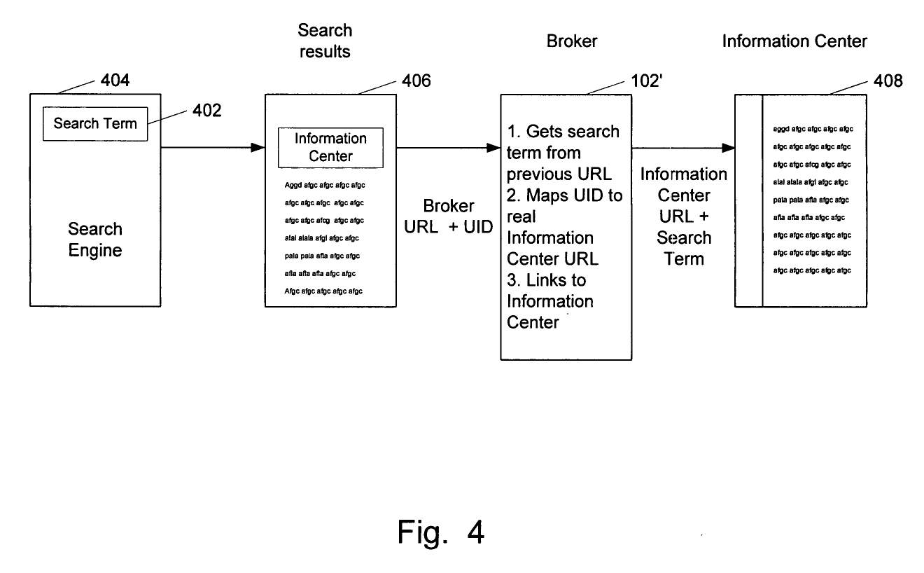

FIG. 4 is a diagram which illustrates the search for a self-contained document in accordance with the present invention. A search term 402 is entered into a search engine 404. The search results 406 are then sent to the broker 102′, with the assigned broker URL and UID. The broker 102′ in a preferred embodiment is a Java server page that serves two purposes: (1) it obtains the search URL to get the user's search term(s), and (2) redirects the request to the appropriate Information Center 408 based on an assigned UID (Information Center assigned serial number). Each Information Center 408 must have a unique serial number. Before indexing a new Information Center 408, the broker 102′ must be updated with the new serial number and the new URL of the new Information Center 408.

As mentioned above, the broker 102′ must be updated before the indexing tool (not shown) is configured for a new Information Center 408. It is the responsibility of the administrator (not shown) to assign a unique UID for each Information Center 408. for example, a naming convention could be IC0000X where the first Information Center is IC00001 and the UIDs are assigned by increasing the value like IC00002, IC00003, etc.

The broker 102 as above-described is an intelligent mediator which allows for a first search engine to quickly access a properly indexed self-contained document (i.e., Information Center). The broker 102 has logic therewithin which allows for this functionality.

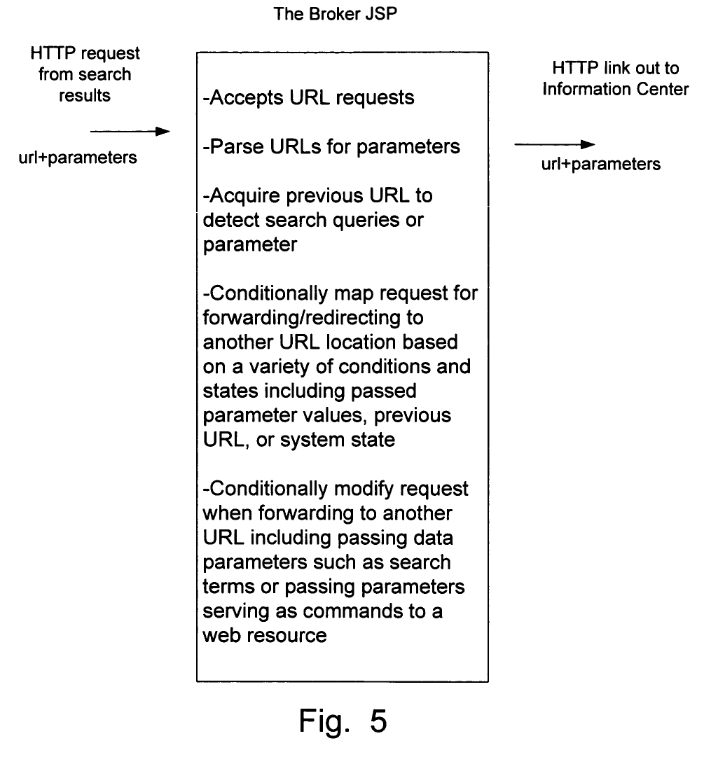

FIG. 5 is a block diagram which illustrates the broker's 102 capability. The broker 102:

(a) Accepts URL requests.

(b) Contains logic to parse URLs for parameters.

(c) Contains logic (can be coded) to acquire previous URL to detect search queries or parameter.

(d) Contains logic to conditionally map request for forwarding/redirecting to another URL location based on a variety of conditions and states including passed parameter values, previous URL, or system state.

(e) Contains logic to conditionally modify request when forwarding to another URL including passing data parameters such as search terms or passing parameters serving as commands to a web resource.

(f) Maintains a list of mapping relations between a passed parameter value(s) and an associated URL location to transfer or redirect the request.

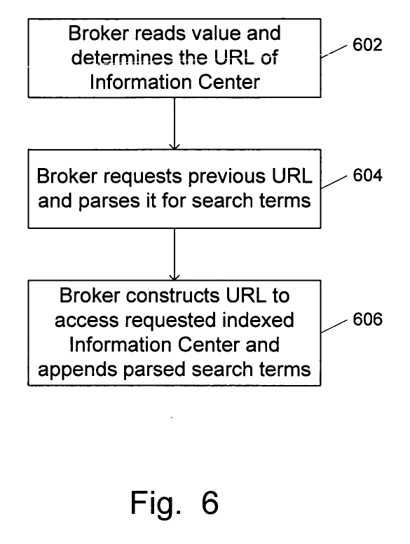

FIG. 6 is a flow diagram of a first embodiment which illustrates an example of how a system and method in accordance with the present invention operates in the case of calling an indexed Information Center from search engine's results page and passing the request to a broker. First, the broker reads a value (parameter) attached to the URL and uses that value to determine the URL of a published Information Center, via step 602. Such a parameter might be, for example, UID=IC001 and the URL of the published Information Center is URL=www.xxx.com/xxxlmy broker/jsp?. It is standard technique to include the search string in the URL generated by search applications. The broker then requests the previous URL and parses it for search terms, via step 604. Finally, the broker constructs a URL to access the requested indexed Information Center in search mode and appends the search term parsed from the previous step, via step 606. The outcome: by clicking on a single link, the Information Center opens up in search mode using the same search terms as initially entered in the original search engine without the user needing to do anything other than click on the link in the search results.

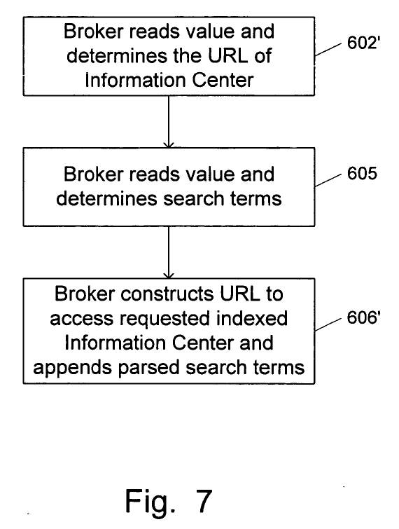

FIG. 7 is a flow diagram of a second embodiment which illustrates an example of how a system and method in accordance with the present invention operates in the case of calling an indexed Information Center from search engine's results page and passing the request to a broker. As can be seen the Step 604 of FIG. 6 has been replaced with step 605 of FIG. 7. In this embodiment, the search term is by the search results application appended to the URL calling the broker along with the UID.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for a text based search comprising:
providing search results which include at least one indexed self contained document;
obtaining a search term from a previous URL of the at least one self-contained document by a broker, the broker including the unique identifier (UID) of the at least one self contained document;
mapping the UID to an actual URL of the at least one included self contained document by the broker; and
linking to the at least one self contained document, by the broker.

2. The method of claim 1 wherein the self contained document comprises an Information Center.

3. The method of claim 1 wherein the self contained document is indexed by providing a plurality of pages of the document as a single file, providing the unique identifier (UID) for the document.

4. The method of claim 1 wherein the broker is configured to redirect link request to the self contained document.

5. The method of claim 1 wherein the search term is obtained by requesting a previous URL and pursing the previous URL for the search tgerm.

6. The method of claim 1 wherein the search term is obtained by reading a parameter value and determing the search term.

7. The method of claim 1 wherein the broker comprises a java server page.

8. A computer readable medium containing program instructions for a text based search comprising:
providing search results which include at least one indexed self contained document;
obtaining a search term from a previous URL of the at least one self-contained document by a broker, the broker including the unique identifier (UID) of the at least one self contained document;
mapping the UID to an actual URL of the at least one included self contained document by the broker; and
linking to the at least one self contained document, by the broker.

9. The computer readable medium of claim 8 wherein the self contained document comprises an Information Center.

10. The computer readable medium of claim 8 wherein the self contained document is indexed by providing a plurality of pages of the document as a single file, providing the unique identifier (UID) for the document.

11. The computer readable medium of claim 8 wherein the broker is configured to redirect link request to the self contained document.

12. The computer readable medium of claim 8 wherein the search term is obtained by requesting a previous URL and pursing the previous URL for the search term.

13. The computer readable medium of claim 8 wherein the search term is obtained by reading a parameter value and determining the search term.

14. The computer readable medium of claim 8 wherein the broker comprises a java server page.

15. A method for indexing a self contained document to allow for a text search, the method comprising:
obtaining a plurality of pages from the self contained document;
sequentially appending the pages to provide a single file;
submitting the single file to a search engine indexer; and
ensuring that the self contained document includes a unique identifier (UID).

16. The method of claim 15 wherein the single file comprises the entire self contained document.

17. The method of claim 15 wherein the single file comprises a portion of the self contained document.

18. A computer readable medium containing program instructions for indexing a self contained document to allow for a text search, the method comprising:
obtaining a plurality of pages from the self contained document;
sequentially appending the pages to provide a single file;
submitting the single file to a search engine indexer; and
ensuring that the self contained document includes a unique identifier (UID).

19. The computer readable medium of claim 18 wherein the single file comprises the entire self contained document.

20. The computer readable medium of claim 18 wherein the single file comprises a portion of the self contained document.

21. A broker for allowing a search engine to access an indexed self contained document; the broker comprising:
logic for parsing URLs for parameter, for acquiring a previous URL to detect search parameters; for mapping a unique identifier of the self contained document to an actual URL of the document.
